(19) United States
(12) Patent Application Publication
(10) Pub. No.: US 2018/0330449 A1
(43) Pub. Date: Nov. 15, 2018

(54) Method for Automated Insured Loss Claim Profile Determination

(71) Applicant: The Manitoba Public Insurance Corporation, Winnipeg (CA)

(72) Inventors: Hugh Bryan Reeves, Winnipeg (CA); Rachel Grenier, Winnipeg (CA); Amelia Klassen, Winnipeg (CA); Jennifer Letkemann, Winnipeg (CA); Brad Taylor, Winnipeg (CA); Mathew Taylor, Winnipeg (CA); Guy Zeaton, Winnipeg (CA); Tennyson Quan, Winnipeg (CA); Curtis Ray, Winnipeg (CA)

(21) Appl. No.: 15/619,744

(22) Filed: Jun. 12, 2017

Related U.S. Application Data
(60) Provisional application No. 62/504,658, filed on May 11, 2017.

(51) Int. Cl. G06Q 40/08; G06Q 10/10

(52) U.S. Cl. CPC G06Q 40/08; G06Q 10/10

(57) ABSTRACT

Described herein is an automated method for the preparation of an accident profile or notice of loss as part of an insured claim submission.

### PRIOR APPLICATION INFORMATION

The instant application claims the benefit of U.S. Provisional Patent Application 62/504,658, filed May 11, 2017 and entitled “METHOD FOR AUTOMATED INSURED LOSS CLAIM PROFILE DETERMINATION”, the contents of which are incorporated herein by reference.

### BACKGROUND OF THE INVENTION

Often, the most stressful part of damage or loss of insured property is the reporting of the claim. Specifically, some insurers have set hours during which time claims adjusters or evaluators are available. Call volumes during these hours can be high, resulting in long wait times, which often feel longer to the insured. Furthermore, the process of reporting a claim at least initially is strictly a verbal process. As such, insured individuals are often stressed out and frustrated by the process of reporting a claim.

What is needed is a process that would empower the insured to be able to more quickly and easily report their claims on their own schedule and with greater control over the process.

### SUMMARY OF THE INVENTION

According to an aspect of the invention, there is provided a method of generating an accident profile comprising:

connecting an individual who has been involved in an accident with an accident profile reporting system, the accident profile reporting system:

prompting the individual to enter customer identification information;

prompting the individual to define their role in the accident;

prompting the individual to define the type of accident;

prompting the individual to enter accident details;

presenting vehicle information to the individual for confirmation;

determining if the individual has a valid insurance policy and carrying out a series of tests against coverage of the policy;

asking the individual a series of compliance questions;

prompting the individual to answer of series of questions for generation of a collision scenario;

if the accident is a multi-vehicle collision on a roadway, presenting the individual with a series of images related to the collision scenario and prompting the individual to select one collision scenario image,

prompting the individual to enter the type of traffic control device in their lane;

determining the type of traffic control device in the lane of the other vehicle and confirming with the individual;

prompting the individual to enter data related to the other party;

asking the individual if there are any other parties involved in the accident;

prompting the individual to enter information regarding damage to their vehicle;

prompting the individual to enter Traffic Accident Report (TAR) data;

prompting the individual to enter information regarding any bodily injuries; and

using information provided by the individual as well as information determined from the individual's replies to generate a statement regarding the accident which is presented to the individual for review;

wherein if the statement is accepted, the accident profile reporting system forwards the statement to the individual's insurance carrier and the individual is informed of their responsibility for the accident.

### DESCRIPTION OF THE PREFERRED EMBODIMENTS

Unless defined otherwise, all technical and scientific terms used herein have the same meaning as commonly understood by one of ordinary skill in the art to which the invention belongs. Although any methods and materials similar or equivalent to those described herein can be used in the practice or testing of the present invention, the preferred methods and materials are now described. All publications mentioned hereunder are incorporated herein by reference.

Described herein is an automated method for the preparation of an accident profile or notice of loss as part of an insured claim submission.

As will be apparent to one knowledgeable in the field of insurance and insurance claims, the Notice of Loss is typically a document detailing the losses, for example, theft and/or destruction of property, and the circumstances surrounding how they occurred.

As will be appreciated by one of skill in the art, the insured item suffering damage or loss may be any insured item, for example but by no means limited to: a vehicle such as a car, truck, motorcycle, boat or the like; a consumer item such as jewelry, electronics or the like; one or more individuals; or a dwelling such as a house or cottage.

In some embodiments, the accident profile is prepared and submitted by the individual without communication with a claims adjuster. That is, the process is “automated” in that the system prompts the individual or user to enter information, not a claims adjuster.

As discussed herein, the invention allows for self-service claim reporting and self-service claim resolution which in turn results in consistent claim outcomes while optimizing customer experiences and staff effort.

The “accident profile” can be considered as consisting of at least five components: the customer ID, the coverage profile, the loss profile, the damage profile and the wrap up profile.

The coverage profile refers to the details of the insurance policy under which the Notice of Loss is being submitted, for example, the validity of the insurance policy and any conditions associated therewith. In those embodiments wherein the accident involves a motor vehicle, the coverage profile may also include information on the driver of the motor vehicle's license validity and any terms, conditions and/or limitations associated therewith.

The loss profile refers to the customer's version of what happened, that is, how the loss occurred.

The damage profile is a description of what has been damaged or lost. For example, in embodiments wherein the damaged property is a motor vehicle, the damage profile may be a prediction of if the motor vehicle can be repaired or if the motor vehicle will be declared a total loss.

The wrap up profile includes additional information such as passenger and/or witness statements and provides the individual with an outcome of the submitted statement of loss, for example, the option to resolve the claim immediately or to schedule an appointment with a repair shop, remediation partner, or claims adjuster to assist in claims resolution.

In the following example, the reporting of an accident involving a motor vehicle is described for illustrative purposes. However, as will be apparent to one of skill in the art, the automated reporting method is applicable to a variety of scenarios.

According to an aspect of the invention, there is provided a method of generating an accident profile comprising:

connecting an individual who has been involved in an accident with an accident profile reporting system, the accident profile reporting system:

prompting the individual to enter customer identification information;

prompting the individual to define their role in the accident;

prompting the individual to define the type of accident;

prompting the individual to enter accident details;

presenting vehicle information to the individual for confirmation;

determining if the individual has a valid insurance policy and carrying out a series of test against coverage of the policy;

asking the individual a series of compliance questions;

prompting the individual to answer a series of questions for generation of a collision scenario;

if the accident is a multi-vehicle collision on a roadway, presenting the individual with a series of images related to the collision scenario and prompting the individual to select one collision scenario image,

prompting the individual to enter the type of traffic control device in their lane;

determining the type of traffic control device in the lane of the other vehicle and confirming with the individual;

prompting the individual to enter data related to the other party;

asking the individual if there are any other parties involved in the accident;

prompting the individual to enter information regarding damage to their vehicle;

prompting the individual to enter Traffic Accident Reporting (TAR) data;

prompting the individual to enter information regarding any bodily injuries; and

using information provided by the individual as well as information determined from the individual's replies to generate a statement regarding the accident which is presented to the individual for review;

wherein if the statement is accepted, the accident profile reporting system forwards the statement to the individual's insurance carrier and the individual is informed of their responsibility for the accident.

In some embodiments, one of the tests for the purpose of confirming compliance with conditions present on a policy of insurance involves prompting the individual to enter where the driver was driving to and where the driver was driving from;

The customer identification information may include for example but by no means limited to at least one of the following: vehicle license plate number; the operator's driver's license number; the insurance policy number; an email address; home address; telephone number and the like.

In some embodiments, the system confirms the validity of the information entered and/or seeks additional information.

As will be appreciated by one of skill in the art, if an email address is collected, this can be used by the system to forward information to the individual.

As will be apparent to one of skill in the art, the role of the individual initiating the accident profile will of course depend on the nature of the loss. For example, they may be the owner, a tenant, a driver or the like. In embodiments wherein the loss involves at least one motor vehicle, the role of the individual in the loss may be for example that they are the owner of the vehicle involved in the accident, the driver of the vehicle involved in the accident or both.

The type of accident defines in general what has occurred. For example, in those embodiments in which a motor vehicle is involved, the individual may be prompted to select between a single vehicle collision, a multi-vehicle collision, a hit and run, a collision with a cyclist or pedestrian or a comprehensive/non-collision type of claim.

The accident details may include but is by no means limited to the date and time of the loss or when the loss was first noticed and when appropriate the location of the loss. For example, when the accident involves a motor vehicle, the individual may enter the approximate address or highway number or cross streets. Alternatively, the individual may be prompted to select the location of the accident on a map or the system may ask the individual if they are at the location of the accident and use for example GPS coordinates or the like to determine the location of the individual.

In some embodiments, the system displays the accident details for the individual prior to finalizing the accident details in the accident profile.

In some embodiments, the system may display the accident profile details recorded to a given point in time for the individual to review and confirm.

In some embodiments of the invention, the method includes one or more gate steps at which point the claim, that is, the data entered, is saved, allowing the individual to exit the system and return at a later time to continue entry of the claim. In some embodiments, these gate stages may correspond with the display of details and confirmation steps of the process. For example, one gate may be following the entry of the accident details while another gate may be following the entry of the damage details, including information on injuries and passengers, as discussed herein.

While the gate steps are convenient for the individual entering the data, they also prevent the individual from being able to change previously entered information at a later date without consulting a claims adjuster.

The accident profile reporting system may forward the accident profile information recorded as per above to the insurance carrier at any of the steps described above, for example, at a gate step as per above.

As will be apparent to one of skill in the art, the insurance carrier may compare the information provided with their records to confirm that it is correct and also to confirm that a duplicate claim is not being submitted. If any information is incorrect, the carrier will inform the accident profile reporting system who in turn asks the individual to confirm the accuracy of the data entries.

In some embodiments of the invention, the accident profile reporting system may provide the individual with a limited number of opportunities to correct the data. As will be apparent to one of skill in the art, this serves two purposes—it limits the entry of frivolous fraudulent data but also allows for the identification of individuals who are having difficulty entering data and may require the assistance of a claims adjuster and/or medical attention.

The vehicle information comprises information such as for example the make and model of the vehicle, driver's license number and the role of the individual.

The initial step of the policy validation process is to determine if the individual has a valid insurance policy. The system then carries out one or more tests against coverage to determine if the insurance policy covers the type of claim or loss. For example, the system may determine the class of vehicle involved in the accident and/or if the driver's seat was occupied at the time of the accident or loss and/or what purpose the vehicle was being used for.

For example, if the driver's seat was occupied at the time of the accident or loss and the individual has indicated that they were the driver of the vehicle but not also the owner of the vehicle (or that they were the owner of the vehicle but not the driver of the vehicle), the accident profile reporting system will ask if the driver had permission from the owner to operate the vehicle.

In some embodiments, the individual is provided with a series of options to select from regarding where the individual was travelling. For example, the individual may select that the individual was driving to or from home, school, work, a business activity, a delivery activity, a personal or leisure activity or an unknown activity. As will be appreciated by one of skill in the art, this information may be used to determine if conditions on either the licence or the insurance policy are being met.

The accident profile reporting system is arranged to ask the individual a series of compliance questions to determine if conditions on their driver's license and/or insurance policy are being met. Thus, the accident profile reporting system may ask the individual other questions to determine if conditions of the insurance policy or driver's license are being met such as if the driver was wearing corrective lenses or what purpose the vehicle was being used for or if the driver had consumed drugs or alcohol within 12 hours prior to the loss or accident and/or if police charges were filed.

For the generation of the collision scenario, the individual is asked a series of questions. These questions are dependent on the type of claim that is being entered, for example, whether the claim is a single vehicle collision claim, a multi-vehicle collision claim, a hit and run claim, a collision with a pedestrian/cyclist claim or a comprehensive/“non-collision” claim.

For example, if the claim is a multi-vehicle collision claim, the individual may be asked if the collision took place on a roadway or in a parking lot. The individual may also be asked if the vehicle was parked when the accident occurred or if the vehicle struck a parked vehicle.

If the collision was a multi-vehicle collision that took place on a roadway, the individual is asked which direction they were travelling, which direction the other vehicle was travelling and where the other vehicle was in relation to their vehicle.

As will be appreciated by one of skill in the art, the individual may be presented an image which is either touched to indicate the direction of movement or includes a series of symbols such as letters or numbers for each direction for each vehicle. Similarly, the individual may be presented with an image that shows a number of possible second vehicle positions for the individual to select, again either by touching the correct image or by entering the symbol or character associated with that image.

Specifically, accident configuration images are well known in the art and are used for describing what has transpired in an accident. Typically, most insurance companies use approximately 150 standardized images. However, such images have not been previously grouped together according to direction of travel and relative position of the vehicles. That is, each of the accident configuration images is placed in one or more groups according to the direction of travel of the two vehicles and their relative positions. The individual is then presented with a relevant subset of the images one at a time and selects the one that best describes what occurred.

That is, by selecting their direction of travel, the direction of travel of the other vehicle and the position of the other vehicle relative to their vehicle, the individual is presented with a subset of accident configuration images from which to choose, thereby facilitating the process of selecting the accident configuration image that best describes what occurred in their accident. That is, each standardized accident collision image is associated with one or more (but not all) set of movement and location responses so that the individual only reviews the most relevant accident collision images, that is, a specific subset of the set of 150 standardized accident collision images.

The accident profile reporting system then asks the individual what type of traffic control device regulated the lane in which they were travelling, for example, traffic lights, a stop sign, a yield sign, no control or unknown control.

The accident profile reporting system then determines what the most likely traffic control device for the other vehicle is and asks the individual to confirm that this is correct.

For example, if the individual's lane was regulated by a stop sign, it is likely that the lane of the other party was regulated by a stop sign as well.

Once the type of traffic control has been established, the system has sufficient information to make an initial assessment of the responsibility of each party for the accident.

If the collision occurred in a parking lot or one of the vehicles involved in the collision was parked, the questions asked by the system are different as the rules governing traffic interactions under these conditions are different. However, in all cases, the system asks sufficient questions so that an initial assessment of the responsibility of each party involved can be determined.

The third party information may include the license plate of the other vehicle, the driver's license number of insurance policy number of the other driver or a description of the other vehicle, depending on what information the individual has been able to obtain, depending on the nature of insurer. This additional information may include the contact information for the individual, for example, date of birth and address.

The system then asks the individual if there are any other parties involved in the accident, for example, another vehicle, passengers or witnesses or others who may have suffered a loss as a result of the accident such as a property owner. If the individual answers in the affirmative, the system will gather information on each additional individual as per above for the driver of the other vehicle.

The individual enters information regarding damage to their vehicle. As will be appreciated by one of skill in the art, if the claim is a comprehensive/non-collision claim, the system does not request any information.

Alternatively, the accident profile system asks the individual if the vehicle suffered damages that the individual wishes to claim. If the individual answers “yes”, the accident profile system asks the individual if the vehicle can be safely driven.

If the answer is “no”, the accident profile system may dispatch a tow truck to the location of the vehicle. For example, the accident profile system may ask the individual if the vehicle requires a tow or if the vehicle has already been towed. If necessary, the accident profile system may ask the individual for the location of the vehicle if this information has not been previously provided, as discussed above. Alternatively, the accident profile system may request that the individual enter pick up instructions to be relayed to the tow truck driver.

As will be appreciated by one of skill in the art, the individual may enter details regarding the damage to their vehicle by any of a number of means known in the art. For example, the individual may be prompted to take photos of the damaged area. Alternatively, the individual may be provided with one or more images of a car or the exterior portions of a car and asked to indicate which areas are damaged. As will be appreciated by one of skill in the art, in some embodiments, combinations of these methods may be used.

The accident profile reporting system asks the individual if they have suffered any bodily injuries. The accident profile reporting system may then ask the individual if there were any passengers in the car and if any of the passengers suffered any injuries.

The accident profile reporting system may ask the individual if there were any child restraint seats in the vehicle or if there were any witnesses.

In some embodiments, for example, where vandalism, theft, drugs, alcohol and/or injuries are involved, the system may advice the individual to contact the police and file a report.

In some embodiments, the accident profile reporting system may ask a series of questions for statistical profiling of the accident. These statistics may then be forwarded to the appropriate collecting authority for the preparation of local or federal statistics on traffic accidents.

In preparation for the determination of the coverage for the accident, the accident profile reporting system uses the information provided by the individual as well as information determined from the individual's replies to generate a statement regarding the accident which is presented to the individual for review. The individual is presented with the option of accepting the statement or revising it by moving backwards through the steps of the system.

Once the statement has been accepted, the individual is notified that by agreeing to proceed further, a statement of claim will be submitted to their insurance provider on their behalf.

The system then reports the claim to the insurance carrier and receives from the insurance carrier information on the claim.

This represents another gate in the process, meaning that once the statement has been accepted by the individual, the individual cannot make any changes to the statement.

In addition to reporting the claim to the insurance carrier, the accident profile reporting system also provides the individual with a liability determination and an explanation of the basis for the determination. The individual is provided with the opportunity to agree or disagree with this assessment. If the individual agrees, an appointment is arranged for assessment of the vehicle, where required.

If the individual does not agree, the individual is provided with the opportunity to provide additional details regarding the accident which they feel support their position. For example, the individual may be allowed to state why they disagree with the liability determination or alternatively may schedule an appointment or submit photos or other evidence. This information is passed on to the insurance carrier.

In some embodiments, the system provides the individual with additional options regarding an assessment appointment, for example, time and/or location. The individual may also be provided with additional information on the nature of their coverage, for example, if a deductible is waived or must be paid and if so how much the deductible is, or if the individual has “loss of use” coverage and will be entitled to a replacement vehicle.

The scope of the claims should not be limited by the preferred embodiments set forth in the examples but should be given the broadest interpretation consistent with the description as a whole.

1. A method of generating an accident profile comprising:
connecting an individual who has been involved in an accident with an accident profile reporting system, the accident profile reporting system:
prompting the individual to enter customer identification information;
prompting the individual to define their role in the accident;
prompting the individual to define the type of accident;
prompting the individual to enter accident details;
presenting vehicle information to the individual for confirmation;
determining if the individual has a valid insurance policy and carrying out a series of test against coverage of the policy;
asking the individual a series of compliance questions;
prompting the individual to answer of series of questions for generation of a collision scenario;
if the accident is a multi-vehicle collision on a roadway, presenting the individual with a series of images related to the collision scenario and prompting the individual to select one collision scenario image,
prompting the individual to enter the type of traffic control device in their lane;
determining the type of traffic control device in the lane of the other vehicle and confirming with the individual;
prompting the individual to enter data related to the other party;
asking the individual if there are any other parties involved in the accident;
prompting the individual to enter information regarding damage to their vehicle;
prompting the individual to enter Traffic Accident Report (TAR) data;
prompting the individual to enter information regarding any bodily injuries; and
using information provided by the individual as well as information determined from the individual's replies to generate a statement regarding the accident which is presented to the individual for review;
wherein if the statement is accepted, the accident profile reporting system forwards the statement to the individual's insurance carrier and the individual is informed of their responsibility for the accident.
